(19) United States
(12) Patent Application Publication
(10) Pub. No.: US 2006/0072241 A1
(43) Pub. Date: Apr. 6, 2006

(54) System, method, and apparatus for a wireless hard disk drive

(76) Inventors: Norbert A. Feliss, Sunnyvale, CA (US); Donald Ray Gillis, San Jose, CA (US); Andrei Khurshudov, San Jose, CA (US)

Correspondence Address: Chambliss, Bahner & Stophel, P.C., Two Union Square, 1000 Tallan Building, Chattanooga, TN, 37402, US

(21) Appl. No.: 10/955,404

(22) Filed: Sep. 30, 2004

(51) Int. Cl. G11B 33/14; G11B 23/03; G06F 1/16

(52) U.S. Cl. 360/97.02; 361/685; 360/133

(57) ABSTRACT

A sealed Hard Disk Drive filled with an inert gas mixture of air, helium, and/or nitrogen provides a wireless data encrypted interface to facilitate data and control transfer with a host system. The wireless interface additionally allows power transfer through Radio Frequency (RF) propagation or electromagnetic induction. Extended measures for vibration, shock, and temperature control are made possible through the use of the wireless interface. Immersion of the HDD into a viscous gel, or other damping material, provides vibration and shock control, while heating/cooling coils provide temperature control.

### BACKGROUND OF THE INVENTION

1. Field of the Invention

This invention relates in general to Hard Disk Drives (HDD), and more particularly to a system, method, and apparatus for extended physical protection of an HDD having wireless power and control interfaces.

2. Description of Related Art

Magnetic recording is a key and invaluable segment of the information-processing industry. While basic principles are one hundred years old for early tape devices, and over forty years old for magnetic HDDs, an influx of technical innovations continues to extend the storage capacity and performance of magnetic recording products. For HDDs, the areal density or density of written data bits on the magnetic medium has increased by a factor of more than two million since the first disk drive was applied to data storage. Since 1991, the areal density has grown by a 60% compound growth rate, which is based on corresponding improvements in heads, media, drive electronics, and mechanics.

Along with increased areal density, HDDs are advancing with respect to other design parameters such as size, weight, and power consumption. HDD applications in mobile devices such as laptop computers, for example, have forced the size, weight, and power consumption specifications of the HDDs downward, while their respective performance parameters are expected to be increased.

In addition, the operating environment of HDDs in mobile devices continues to be a design challenge. For example, HDDs internal to laptop computers must tolerate harsh environments, where shock, vibration, and temperature are taken to the extreme. Thus, not only are the size, weight, and power consumption parameters of the HDDs becoming more challenging, but these parameters must all be met while the mobile device is also subjected to an unusually punishing physical environment.

To counteract this punishing physical environment, some prior art mobile computing platforms are designed with aluminum or magnesium casings, as opposed to molded plastic, for added strength. The keyboard and Input/Output (I/O) ports are sealed against dirt and liquids, and critical internal devices, such as the HDDs, are shock mounted. Often, these “ruggedized” mobile computers are subjected to rigorous tests, such as the MIL-STD 810E military tests, to determine their aptitude for the harsh physical environment. Under MIL-STD 810E testing, for example, a multitude of tests are performed to include: free fall drop tests, hot operation at a stabilized temperature of 159.8° F. for 4 hours; sudden change in temperature test from −27.4° F. to +159.8° F., and a sprayed liquid test.

While these ruggedized mobile computing platforms provide shock mounts for their internally mounted HDDs, it remains questionable as to what extent these shock mounts are effective to prevent immediate, catastrophic disk crashes, or latent damage effects that may be caused by excessive vibration or shock. It remains equally questionable as to what amount of temperature variation control (if any) is provided by prior art mobile computing platforms. Still further, these prior art mobile computing platforms are often twice the cost of their non-ruggedized counterparts due to the increased mechanical integrity.

It can be seen, therefore, that there is a need for an HDD design that is conducive to ruggedization measures taken to facilitate maximized resistance to shock and vibration, while providing improved temperature variation control. Such a HDD design would also reduce the mechanical integrity required by prior art ruggedization techniques and thus would reduce the costs associated with such mechanical integrity requirements.

### SUMMARY OF THE INVENTION

To overcome the limitations in the prior art described above, and to overcome other limitations that will become apparent upon reading and understanding the present specification, the present invention discloses a system, method and apparatus for a hard disk drive that allows maximum physical isolation from the environment through the use of a wireless interface that is conducive to such maximized physical isolation.

In one embodiment of the present invention, a method of extended physical protection for a Hard Disk Drive (HDD) in operation within a host system, comprises sealing the HDD, encapsulating the HDD within a damping material, wirelessly exchanging data and control signals between the host system and the HDD through the damping material, and wirelessly providing power to the HDD through the damping material.

In another embodiment of the present invention, a storage system comprises a sealed Hard Disk Drive (HDD). The sealed HDD comprises a wireless interface that is adapted to wirelessly exchange data and control signals with a host system. The storage system further comprises a physical isolation device that is adapted to encapsulate the HDD through immersion within a damping substance, and an Input/Output (I/O) interface wirelessly that is coupled to the wireless interface and is adapted to convert host system data to a wireless format, where the wireless format is compatible with the wireless interface.

In another embodiment of the present invention, a Hard Disk Drive (HDD), comprises a magnetic recording medium, a read/write head disposed proximate to the recording medium, a data channel coupled to the read/write head and adapted to exchange storage data with the read/write head, and a signal processor coupled to the data channel and adapted to translate the storage data into a wireless format. The wireless format is adapted to wirelessly traverse protective material encapsulating the HDD.

These and various other advantages and features of novelty which characterize the invention are pointed out with particularity to the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, method, and apparatus in accordance with the invention.

### BRIEF DESCRIPTION OF THE DRAWINGS

Referring now to the drawings in which like reference numbers represent corresponding parts throughout:

FIG. 1 illustrates a storage system according to the present invention;

FIG. 2 illustrates one particular embodiment of a storage system according to the present invention;

FIG. 3 illustrates a slider mounted on the suspension of the storage system of FIG. 2;

FIG. 4 illustrates an ABS view of the slider and the magnetic recording head of FIG. 3;

FIG. 5 illustrates a detailed block diagram of the Input/Output (I/O) interfaces of the storage system of FIG. 1;

FIG. 6 illustrates a Bluetooth stack hierarchy used to implement a wireless interface in accordance with the present invention;

FIG. 7 illustrates a communication architecture in accordance with the present invention; and

FIG. 8 illustrates a physical isolation device in accordance with the present invention.

### DETAILED DESCRIPTION OF THE INVENTION

In the following description of the exemplary embodiment, reference is made to the accompanying drawings which form a part hereof, and in which is shown by way of illustrating the specific embodiments in which the invention may be practiced. It is to be understood that other embodiments may be utilized as structural changes may be made without departing from the scope of the present invention.

The present invention provides a system, method, and apparatus that allow wireless access to an HDD. Such access allows extended physical isolation measures to be taken to protect the HDD from shock, vibration, and temperature variation. A wireless, multi-signal controller is integrated and multiplexed with the HDD file interface control electronics to provide all signal conversion, power transfer, and communication to the HDD that may be required. The controller maintains a conventional customer interface, such that the wireless HDD remains fully functional with existing host systems.

In another embodiment according to the present invention, an enclosure for the wireless HDD is contemplated, which provides extended physical protection of the HDD through isolation. The wireless HDD is immersed within a viscous gel such as hydrocarbon, fluorocarbon, or silicone polymer, and is suspended in the center of the gel through the use of suitably placed ribs, so that the HDD may remain centralized within an enclosure, e.g., a bag, that contains the gel, ribs, and HDD. As such, the HDD is protected by the high viscosity of the gel, which impedes the translation progress of the HDD in any x, y, and/or z direction. Thus, immersion of the HDD within the gel acts as a critically damped system during acceleration or deceleration events.

In accordance with another embodiment of the invention, the HDD is filled with air, helium, nitrogen, or a combination of these inert gases before the drive is permanently sealed. Inert gases other than air are used with high-performance hard disk drives which have magnetic heads flying at very low head/disk spacing (e.g., less than 8 nanometers (nm)). The HDD is then protected by the encapsulation and shock insulation as described in more detail below.

One purpose for utilizing inert gases is to provide an internal environment for high performance head/disk stability. The magnetic head exhibits improved signal to noise amplification when helium or nitrogen is used rather than air. Furthermore, the viscosity change between air and nitrogen and air and helium causes damping in the HDD, thus reducing the Repeatable Run Out (RRO) and Non-Repeatable Run Out (NRRO), which subsequently reduces disk flutter to enhance the head/disk compliance.

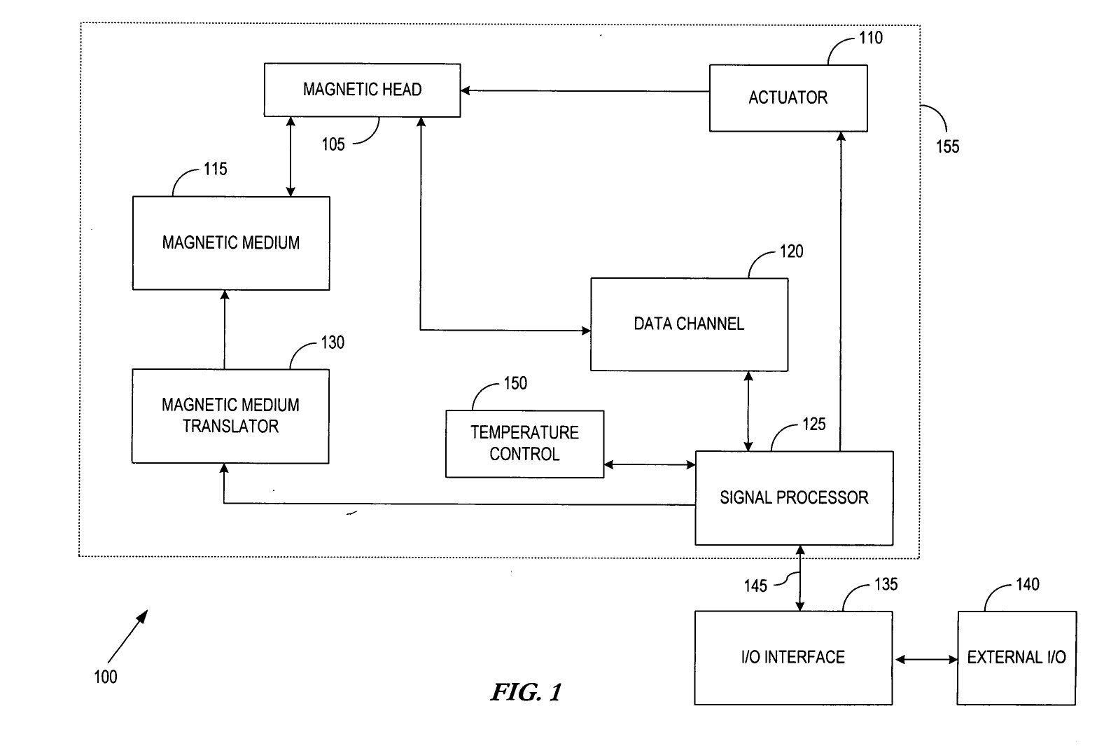

FIG. 1 illustrates an exemplary storage system 100 that utilizes the wireless HDD in accordance with the present invention. A magnetic head 105 is under control of an actuator 110, whereby the actuator 110 controls the position of the magnetic head 105. The magnetic head 105 writes and reads data on magnetic medium 115. The read/write signals are passed to/from a data channel 120. A signal processor 125 controls the actuator 110 and processes the signals of the data channel 120 for data exchange with I/O interface 145. I/O interface 145 may provide, for example, data and control conduits for a laptop computing application which utilizes the storage system 100. In addition, magnetic medium translator 130 is controlled by the signal processor 125 to cause the magnetic medium 115 to move relative to the magnetic head 105. The present invention is not meant to be limited to a particular type of storage system 100 or to the type of magnetic medium 115 used in the storage system 100.

In one embodiment according to the principles of the present invention, for example, components relating to a particular HDD of storage system 100 may be fully encapsulated within a physical isolation device 155. The physical isolation device, while providing maximum protection to the HDD against shock, vibration, and temperature variation, is also restrictive as to the particular I/O implementation that may be allowable. I/O interface 135 thus provides a standard interface to external I/O 140, which serves as the conventional interface to the computing system (not shown) or other host system that is utilizing storage system 100, while also providing the necessary signal conversion, power transfer, and communication links that may be required by the HDD via communication link 145.

Communication link 145 represents a multi-signal interface that provides, among other signals, wireless power transfer and wireless communication, where the communication may be implemented via any one of a number of wireless protocols, such as Bluetooth, Infrared (IR), or a wireless Local Area Network (LAN) specification, such as the family of specifications defined by the Institute of Electronics and Electrical Engineers (IEEE) 802.11. As such, the wireless communication actually implemented may also be encrypted in accordance with the particular protocol in use.

Communication link 145 may also provide the temperature control signals that are operative to maintain physical isolation device 155 within an allowable temperature range via temperature control 150. As discussed in more detail below, temperature control 150 may interact with signal processor 125 to control a wire heater and a chemical refrigerant to control heating and cooling, respectively, of the viscous gel, for example, that may be contained within physical isolation device 155.

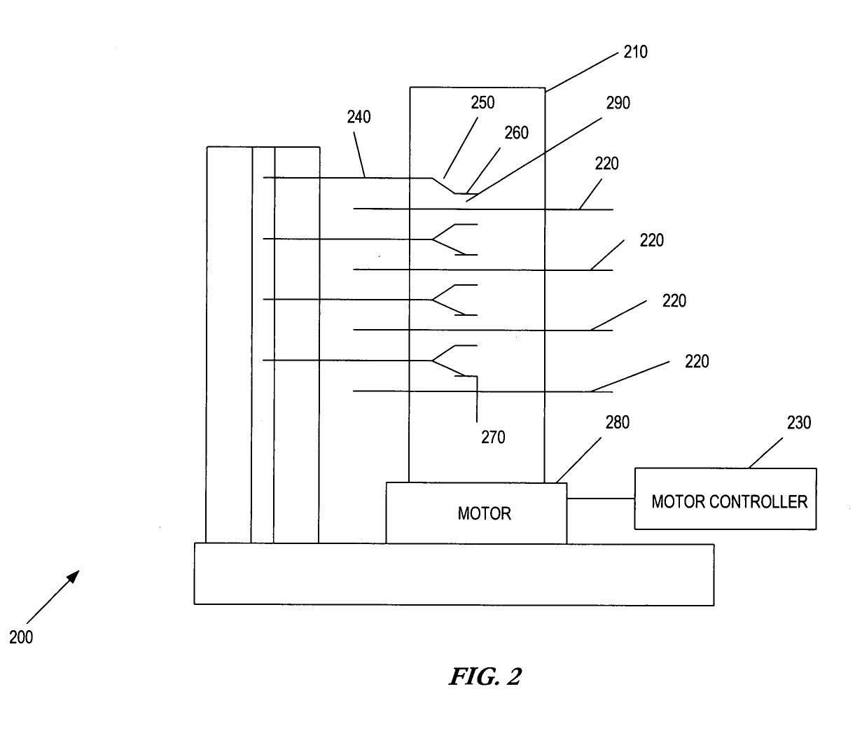

FIG. 2 illustrates one particular embodiment of a multiple magnetic disk storage system 200 according to the present invention. In FIG. 2, a HDD storage system 200 is shown. The storage system 200 includes a spindle 210 that supports and rotates multiple magnetic disks 220. The spindle 210 is rotated by a motor 280 that is controlled by a motor controller 230. At each surface of each magnetic disk 220, there is a magnetic head 270. The magnetic head 270 is mounted on a slider 260 that is supported by a suspension 250 and an actuator arm 240. Processing circuitry exchanges signals that represent write/read information with the magnetic head 270, provides motor drive signals for rotating the magnetic disks 220, and provides control signals for moving the slider 260 to various tracks. Although a multiple magnetic disk storage system is illustrated, a single magnetic disk storage system is equally viable in accordance with the present invention.

The suspension 250 and the actuator arm 240 position the slider 260 so that the magnetic head 270 is in a transducing relationship with a surface of the magnetic disk 220. When the magnetic disk 220 is rotated by a motor 280, the slider 240 is supported on a thin cushion of air, i.e., Air Bearing Surface (ABS), between the surface of the magnetic disk 220 and the ABS 290. The magnetic head 270 may then be employed for writing information to multiple circular tracks on the surface of the magnetic disk 220, as well as for reading information therefrom.

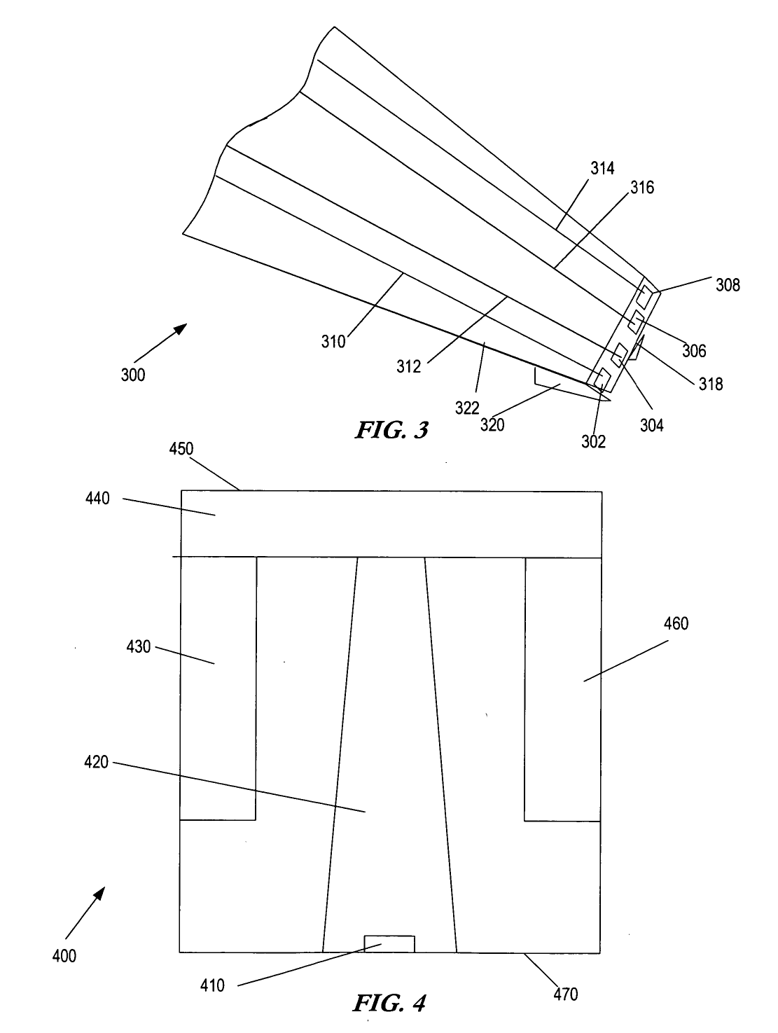

FIG. 3 illustrates slider/suspension combination 300 having a slider 320 mounted on a suspension 322. First and second solder connections 302 and 308 connect leads from the magnetic sensor 318 to read data leads 310 and 314, respectively, on the suspension 322 and third and fourth solder connections 304 and 306 connect to the write coil (not shown) to write data leads 312 and 316, respectively, on the suspension 322.

FIG. 4 is an ABS view of a slider 400 and a magnetic head 410. The slider has a center rail 420 that supports the magnetic head 410, and side rails 430 and 460. The support rails 420, 430 and 460 extend from a cross rail 440. With respect to rotation of a magnetic disk, the cross rail 440 is at a leading edge 450 of the slider 400 and the magnetic head 410 is at a trailing edge 470 of the slider 400.

The above description of a typical magnetic recording disk drive system, shown in the accompanying FIGS. 2-4, are for presentation purposes only. Disk drives may contain a large number of disks and actuators, and each actuator may support a number of sliders. In addition, instead of an air-bearing slider, the head carrier may be one which maintains the magnetic head in contact or near contact with the magnetic disk, such as in liquid bearing and other contact and near-contact recording disk drives.

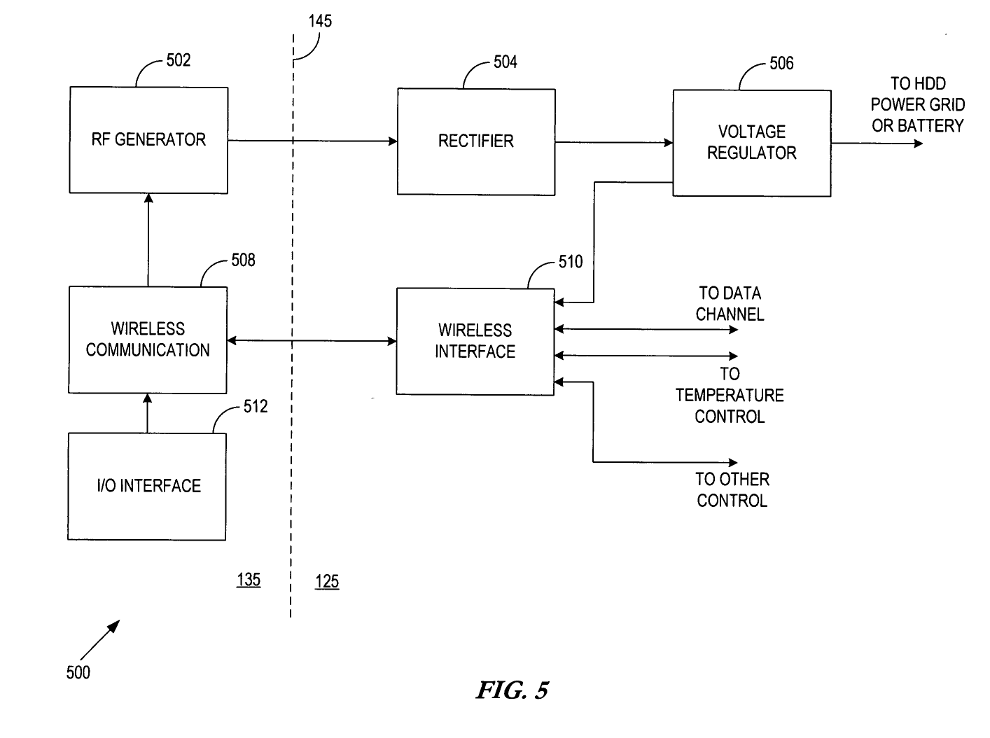

Referring to FIG. 5, a detailed block diagram of I/O interface 135 and signal processor 125 of FIG. 1 are exemplified in accordance with the present invention. As discussed above, I/O interface 135 provides a standard interface 512 to external I/O 140, which serves as the conventional interface to the computing system, or other host system, that is utilizing storage system 100, while also providing the necessary signal conversion, power transfer, and communication that may be required by the HDD (not shown) via communication link 145. Power transfer to the HDD may be affected in any one of a number of power transfer techniques, such as Radio Frequency (RF) or electromagnetic induction transfer as discussed in more detail below.

It should be noted that communication link 145 may also be encrypted through encryption/decryption devices (not shown) within wireless communication 508 and wireless interface block 510. The encryption devices may implement, for example, a Wired Equivalent Privacy (WEP) protocol should communication link 145 be operating in accordance with the IEEE 802.11 standard.

In a first embodiment of power transfer, RF energy is propagated to provide the power required by the HDD to operate. RF generator 502 may exemplify virtually any mode of RF signal generation that may be rectified by rectifier 504. For example, the RF signal generated by RF generator 502 may be an Amplitude Modulated (AM) signal anywhere within the Megahertz (MHz) to Gigahertz (GHz) range, whereby communication link 145 represents an Over-The-Air (OTA) link capable of supporting the AM signal.

In an alternate embodiment of power transfer, electromagnetic induction techniques may be utilized, such that the energy generated by RF generator 502 is coupled to rectifier 504 via electromagnetic induction. In such an instance, a relatively large Alternating Current (AC) signal is conducted through a coil (not shown) within RF generator 502 in order to generate a magnetic flux. The magnitude of the generated magnetic flux changes with time, such that a current is induced within a coil (not shown) within rectifier 504, which then subsequently induces an AC voltage within rectifier 504.

Rectifier 504 may represent a full-wave rectifier, for example, whereby positive and negative excursions of the AM signal, or the electromagnetically induced signal, is translated to a smoothed, Direct Current (DC) equivalent of the received signal. The DC equivalent signal may then be received by voltage regulator 506, whereby a DC-DC transformation takes place using either a buck or boost conversion technique, whereby an operating voltage required by the HDD (not shown) is generated for the HDD power grid (not shown) or battery (not shown). Feedback indicative of the regulated voltage error signal may also be generated by voltage regulator 506 and delivered to RF generator 502, via wireless interface 510 and wireless communication block 508, so that the AM modulation or electromagnetic induction may be increased or decreased as required in order to meet the operating voltage specifications of the HDD (not shown).

As discussed above, wireless communication block 508 and wireless interface 510 may be implemented by any one of a number of wireless mechanisms including IR, Bluetooth, and IEEE 802.11. 802.11 refers to a family of specifications developed by the IEEE for wireless LAN technology, which may be used, therefore, to specify the OTA interface of communication link 145 between wireless communication block 508 and wireless interface 510.

802.11 is applied to wireless LANs and provides 1 or 2 Mega-bit-per-second (Mbps) transmission in the 2.4 GHz band using either Frequency Hopping Spread Spectrum (FHSS) or Direct Sequence Spread Spectrum (DSSS). Other variants of the original 802.11 specification also exist, such as 802.11(a), which provides up to 54 Mbps in the 5 GHz band using an orthogonal frequency division multiplexing encoding scheme rather than FHSS or DSSS. Further, 802.11(b) (also known as Wi-Fi) provides 11 Mbps transmission in the 2.4 GHz band using only DSSS. Still further, 802.11(g) provides 20+ Mbps transmission in the 2.4 GHz band using only DSSS. It can be seen, therefore, that wireless interface 510 and wireless communication block 508 need not be co-located, but rather may be located within a range supported by the particular 802.11 standard being utilized.

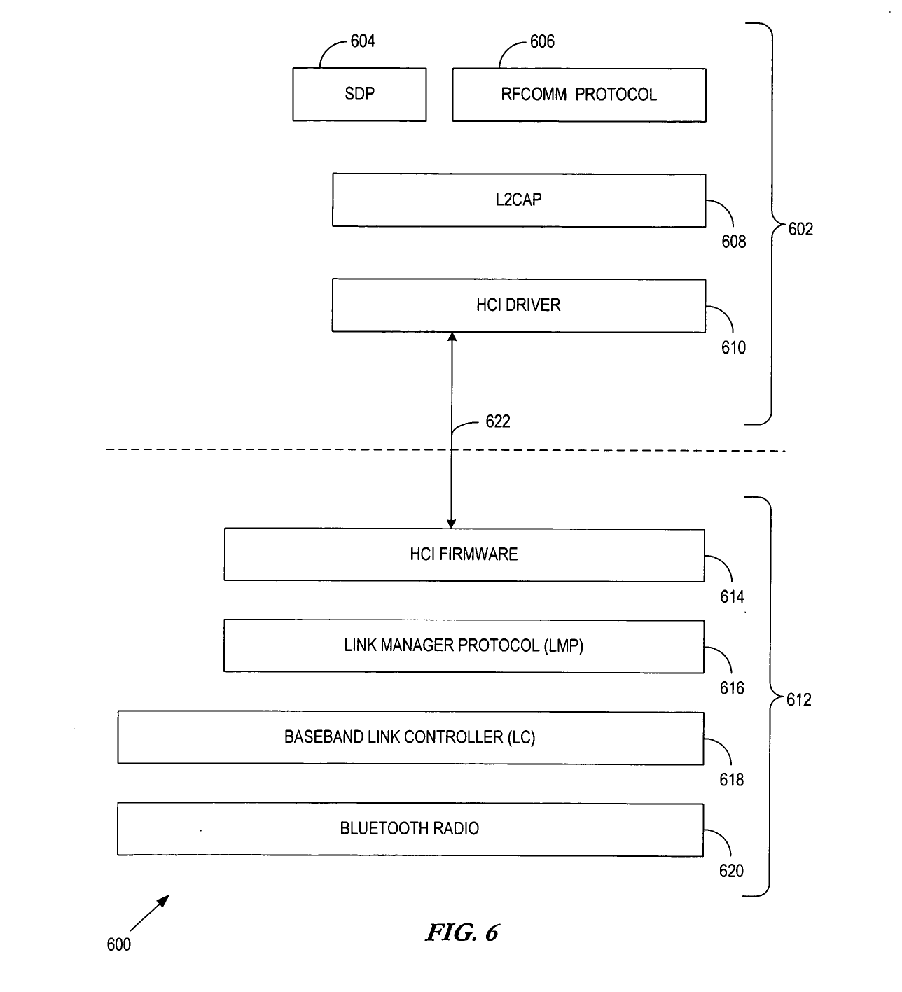

In an alternate embodiment according to the present invention, communication link 145 may represent a Bluetooth link. Like many other communication technologies, Bluetooth is composed of a hierarchy of components that is exemplified in Bluetooth stack hierarchy 600 shown in FIG. 6. The Bluetooth communication stack may be broken into two main components. The first component, Bluetooth Host Controller (BTHC) 612, provides the lower level of the stack. BTHC 612 is generally implemented in hardware and allows the upper level stack, Bluetooth Host (BTH) 602, to send or receive data over a Bluetooth link and to configure the Bluetooth link. Configuration and data transfer between BTHC 612 and BTH 602 takes place via path 622, which connects Host Controller Interface (HCI) driver 610 with HCI firmware module 612.

Bluetooth operates in the 2.4 gigahertz (GHz) Industrial, Scientific, and Medical (ISM) band. It uses a fast frequency hopping scheme with 79 frequency channels, each being 1 MHz wide. Bluetooth Radio (BTR) 620 is designed to provide a low-cost, 64 kbps, full-duplex connection that exhibits low power consumption. Power consumption on the order of 10-30 milliamps (mA) is typical, where even lower power consumption exists during idle periods.

Baseband link controller (LC) 618 defines different packet types to be used for both synchronous and asynchronous transmission. Packet types supporting different error handling techniques, e.g., error correction/detection, and encryption, are also defined within LC 618. LC 618 also mitigates any Direct Current (DC) offsets provided by BTR 620 due to special payload characteristics. Link Manager Protocol (LMP) 616 is responsible for controlling the connections of a device, like connection establishment, link detachment, security management, e.g., authentication, encryption, and power management of various low power modes.

BTH 602 illustrates the upper level of a Bluetooth stack and is comprised primarily of software applications 604-610, and 626. HCI driver 610 packages the high level components that communicate with the lower level hardware components found in BTHC 612. Logical Link Control and Adaptation Protocol (L2CAP) 608 allows finer grain control of the radio link. For example, L2CAP 608 controls how multiple users of the link are multiplexed together, controls packet segmentation and reassembly, and conveys quality of service information.

Service Discovery Protocol (SDP) 604 and Radio Frequency Communication (RFCOMM) protocol 606 represent middleware protocols of the Bluetooth stack. RFCOMM protocol 606 allows applications communicating with Bluetooth stack 600 to treat a Bluetooth enabled device as if it were a serial communications device, in order to support legacy protocols. RFCOMM protocol 606 defines a virtual set of serial port applications, which allows RFCOMM protocol 606 to replace cable enabled communications. The definition of RFCOMM protocol 606 incorporates major parts of the European Telecommunication Standards Institute (ETSI) TS 07.10 standard, which defines multiplexed serial communication over a single serial link.

SDP 604 is used to locate and describe services provided by or available through another Bluetooth device, such as the wireless HDD according to the present invention. SDP 304, therefore, plays an important role in managing Bluetooth devices in a Bluetooth environment by allowing discovery and service description of services offered within the environment. It can be seen, therefore, that through SDP 604, replacement of the wireless HDD according to the present invention is simplified, since the description and allocation of the storage services offered by the replacement HDD may be automatically configured for use without user intervention.

The Bluetooth communication stack of FIG. 6 represents the lower communication layers that support any number of higher level application embodiments according to the present invention. Returning to FIG. 1, for example, I/O interface 135 and signal processor 125 may each employ Bluetooth communication stack 600, in order to facilitate data channel exchange, voltage regulator feedback information, temperature control, and any other control data exchange that may be required between I/O interface 135 and signal processor 125. In addition, the data and control signals exchanged via Bluetooth communication stacks 600 may be encrypted in accordance with the IEEE 802.15 Personal Area Network (PAN) specification.

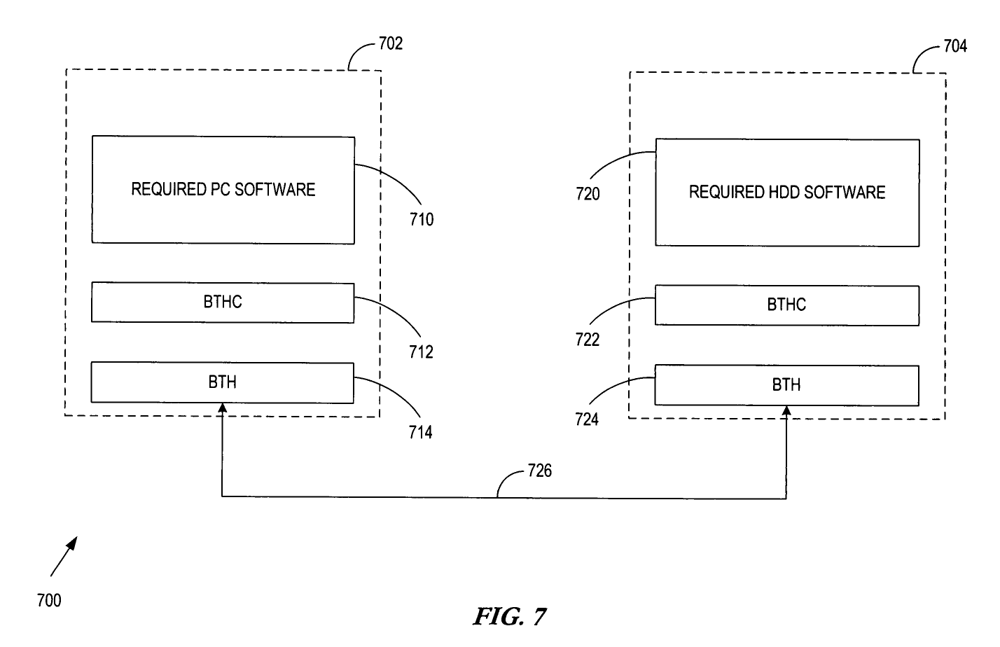

FIG. 7 represents generic communication architecture 700 according to the principles of the present invention, where the BTHC layers, e.g., 712 and 722, and the BTH layers, e.g., 714 and 724, represent the Bluetooth communication stack as illustrated in FIG. 6. HDD 704 represents a wireless enabled storage device according to the present invention, while required HDD software block 720 and related hardware (not shown) establishes the necessary interfaces to actuator 110, data channel 120, and magnetic medium translator 130 of FIG. 1 as required to facilitate proper magnetic medium access.

In addition, required HDD software block 720 may also provide the necessary interfaces that are not magnetic medium access related, such as the temperature control of physical isolation device 155 via temperature control 150 and the provisioning of voltage regulator feedback information that is needed for proper operational voltage control of the HDD power grid or battery.

The host of the wireless HDD according to the present invention may be, for example, a laptop computer or desktop PC 702, which communicates both storage related and operations related data to the HDD via required PC software block 710. Storage related read/write operations between the host PC and the wireless HDD take place in a conventional manner due to the operation of I/O interface 512 of FIG. 5, since I/O interface 135 essentially separates the wireless operating aspects of the wireless HDD from the conventional storage related read/write operations of the HDD in order to make transparent operation possible. Other portions of required PC software block 710 may be configured by the user of the host PC such that, for example, either the operating temperature of physical isolation device 155, or the operating voltage of the HDD, may be programmed by the user as required.

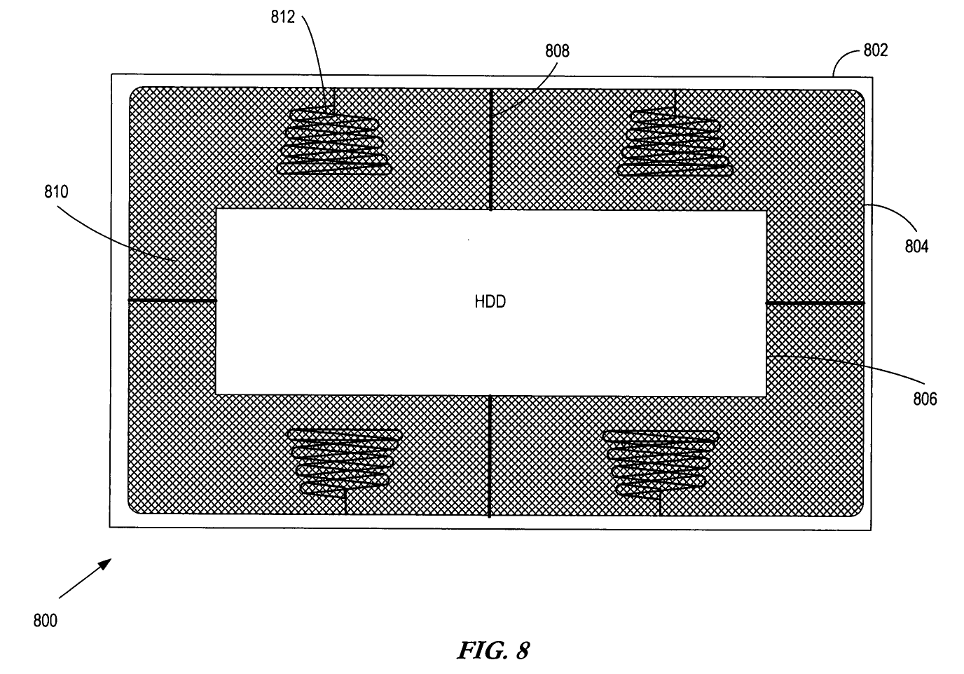

As discussed above, physical isolation device 155 isolates the wireless HDD from the elements of shock, vibration, and/or variations in temperature. In one embodiment according to the present invention, wireless HDD 806 may be fully encapsulated in a viscous gel pack 804 as exemplified by physical isolation device 800 of FIG. 8.

Wireless HDD 806 is sealed and immersed within viscous liquid 810, which may be implemented through the use of a non-corrosive, low-viscosity gel such as a hydrocarbon, fluorocarbon, or silicone polymer within bag 804. HDD 806 is suspended approximately in the center of bag 804, such that HDD 804 is separated from the top, bottom, and sides of crash-proof container 802 by substantially equal distances. A crash-proof container herein will refer to a a container that is designed to withstand impact of the container with another object thereby protecting the HDD 804 from damage, e.g., the box may be designed to maintain the structural integrity of the HDD 804 by controlling and absorbing g-forces of 5000-10000 resulting from such a collision. Optional use of one or more suitably placed ribs 808 may be desirable so that HDD 804 may be centralized within gel 810.

Data and power transmission to HDD 806 is facilitated wirelessly, as discussed above, through the use of a proximately located interface module, e.g., I/O interface 135 of FIG. 1, in conjunction with a wireless enabled controller, e.g., signal processor 125 of FIG. 1, embedded within HDD 806. In operation, encapsulated HDD 806 is protected from shock and vibration by gel 810, which operates to impede the translation progress of HDD 806 in the x, y, and/or z directions.

In addition, variations in ambient temperature surrounding HDD 806, or conversely, variations in the temperature of HDD 806 itself, may also be regulated through the use of coils 812 distributed throughout gel 810. In particular, temperature sensors (not shown) may be used to monitor the temperature at appropriate positions within, or around, HDD 806. The temperature readings may then be supplied to temperature control 150 and compared to predetermined temperature set points, which may have been set by a user of host PC 702 of FIG. 7 through the use of wireless communication block 508 and wireless interface 510 of FIG. 5. Operation of coils 812 may then be appropriately configured to either draw heat away from, or add heat to gel 810 as required to maintain the temperature of HDD 806 substantially equal to the predetermined temperature set points.

The specific operation of coils 812 depends upon whether the predetermined temperature set points are at a higher or lower temperature as compared to the temperature measured for HDD 806. If the temperature of HDD 806 is higher than the predetermined temperature set point, then a refrigerant may be circulated through coils 812 until the temperature is lowered to the predetermined set point. If, on the other hand, the temperature of HDD 806 is lower than the predetermined temperature set point, then coils 812 may be utilized as wire heaters until the temperature is raised to the predetermined set point.

As mentioned above, the present invention provides a system, method and apparatus to facilitate wireless access to an HDD, which then allows extended shock, vibration, and temperature variation control of HDDs to be implemented. In particular, physical isolation device 155 is used to provide critical damping during acceleration or deceleration events that are sustained by the product or host system containing the HDD. In one embodiment, a viscous gel material is used to provide the damping function typically obtained through a hydrocarbon, fluorocarbon or silicone polymer. Other embodiments are contemplated, however, such as the use of highly damped vinyl materials, composites, or specialty foams, to perform substantially the same damping function.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A method of extended physical protection for a Hard Disk Drive (HDD) in operation within a host system, the method comprising:
sealing the HDD;
encapsulating the sealed HDD within a damping material; and
wirelessly exchanging data and control signals between the host system and the HDD through the damping material.

2. The method of claim 1, further comprising filling the HDD with one or more of air, helium, and nitrogen prior to sealing the HDD.

3. The method of claim 1, wherein encapsulating the HDD comprises:
filling a bag with the damping material;
immersing the HDD within the bag; and
supporting the HDD with at least one support rib.

4. The method of claim 3, wherein filling the bag includes using a hydrocarbon, fluorocarbon or silicone polymerized gel.

5. The method of claim 1, further comprising regulating a temperature of the HDD.

6. The method of claim 5, wherein regulating the temperature of the HDD comprises:
immersing coils within the damping material;
circulating a refrigerant through the coils in response to a temperature of the HDD exceeding a predetermined temperature set point; and
heating the coils in response to the predetermined temperature set point exceeding the temperature of the HDD.

7. The method of claim 1, wherein wirelessly exchanging data and control signals comprises formatting the data and control signals according to the 802.11 specification.

8. The method of claim 7, wherein wirelessly exchanging data and control signals further comprises encrypting the data and control signals according to the 802.11 specification.

9. The method of claim 1, wherein wirelessly exchanging data and control signals comprises formatting the data and control signals according to the Bluetooth specification.

10. The method of claim 9, wherein wirelessly exchanging data and control signals further comprises encrypting the data and control signals according to the Bluetooth specification.

11. The method of claim 1, further comprising wirelessly providing power to the HDD through the damping material.

12. The method of claim 11, wherein wirelessly providing power to the HDD comprises propagating Radio Frequency (RF) signals to the HDD.

13. The method of claim 11, wherein wirelessly providing power to the HDD comprises electromagnetically inducing energy to the HDD.

14. A storage system comprising:
a sealed Hard Disk Drive (HDD), the sealed HDD comprising a wireless interface adapted to wirelessly exchange data and control signals with a host system;
a physical isolation device adapted to encapsulate the HDD through immersion within a damping substance; and
an Input/Output (I/O) interface wirelessly coupled to the wireless interface and adapted to convert host system data to a wireless format, the wireless format being compatible with the wireless interface.

15. The storage system of claim 14, wherein the HDD further comprises:
a magnetic recording medium;
a read/write head disposed proximate to the magnetic recording medium; and
a data channel coupled to the read/write head and the wireless interface and adapted to exchange the data signals between the read/write head and the wireless interface.

16. The storage system of claim 14, wherein the physical isolation device comprises:
a crash proof box; and
a bag contained within the crash proof box and adapted to contain the damping substance.

17. The storage system of claim 16, wherein the physical isolation device further comprises a plurality of support ribs immersed within the damping substance and adapted to centralize a position of the HDD within the bag.

18. The storage system of claim 16, wherein the physical isolation device further comprises a plurality of coils immersed within the damping substance and adapted to regulate a temperature of the HDD within the bag.

19. The storage system of claim 14, wherein the wireless format comprises the 802.11 specification.

20. The storage system of claim 14, wherein the wireless format comprises the Bluetooth specification.

21. A Hard Disk Drive (HDD), comprising:
a magnetic recording medium;
a read/write head disposed proximate to the recording medium;
a data channel coupled to the read/write head and adapted to exchange storage data with the read/write head; and
a signal processor coupled to the data channel and adapted to translate the storage data into a wireless format, wherein the wireless format is adapted to wirelessly traverse protective material encapsulating the HDD.

22. The HDD of claim 21, wherein the wireless storage data format conforms to the 802.11 specification.

23. The HDD of claim 21, wherein the wireless storage data format conforms to the Bluetooth specification.

24. The HDD of claim 21, wherein the signal processor is further adapted to receive wirelessly transmitted power signals.

25. The HDD of claim 24, wherein the wirelessly transmitted power signals comprise propagated Radio Frequency (RF) signals.

26. The HDD of claim 24, wherein the wirelessly transmitted power signals comprise electromagnetically induced energy.
